(19) United States
(12) Patent Application Publication
(10) Pub. No.: US 2025/0292099 A1
(43) Pub. Date: Sep. 18, 2025

(54) System and Method for Transformation of Discrete Input for Adversarial Robustness

(71) Applicant: Mitsubishi Electric Research Laboratories, Inc., Cambridge, MA (US)

(72) Inventors: Ye Wang, Cambridge, MA (US); Jing Liu, Cambridge, MA (US); Toshiaki Koike-Akino, Cambridge, MA (US); Kieran Parsons, Cambridge, MA (US)

(73) Assignee: Mitsubishi Electric Research Laboratories, Inc., Cambridge, MA (US)

(21) Appl. No.: 18/605,901

(22) Filed: Mar. 15, 2024

(51) Int. Cl. G06N 3/094

(52) U.S. Cl. CPC G06N 3/094

(57) ABSTRACT

Embodiments disclose a method and a system for robust transformation of a discrete input with a neural network. The neural network including an embedding subnetwork and a transformation subnetwork. The method comprises embedding the discrete input into a continuous space using the embedding subnetwork to produce a continuous embedding, injecting a set of random noises of a predetermined magnitude into the continuous embedding to produce a set of perturbed embeddings, processing each of the set of perturbed embeddings with the transformation subnetwork to produce a set of transformations, and outputting a combination of the set of transformations as the robust transformation of the discrete input.

### TECHNOLOGICAL FIELD

The present disclosure relates generally to training and use of machine learning systems for defense against adversarial input attacks and more particularly to systems and methods for robust transformation of discrete inputs for defense against adversarial input attacks.

### BACKGROUND

Machine learning (ML) models, particularly deep neural networks, have achieved success across various domains, including image recognition, natural language processing, and autonomous systems. However, these ML models are susceptible to adversarial input attacks, where small, carefully crafted perturbations to input data can lead to misclassification or erroneous behavior.

Adversarial input attacks involve making small, carefully crafted modifications to input data with the intention of causing a machine learning (ML) model to misclassify the input data. These modifications are often imperceptible to humans but may significantly alter an output of the ML model. Adversarial attacks exploit vulnerabilities in the ML model by adding perturbations to input data, such as images, text, or audio.

Adversarial attacks pose significant challenges to the deployment of ML models in safety-critical applications, such as autonomous vehicles, medical diagnosis, and cybersecurity systems. Traditional defense mechanisms, including input preprocessing and model regularization, have shown limited effectiveness in overcoming sophisticated adversarial attacks.

In an example, a ML model may have to be defended against adversarial input perturbation attacks, particularly in the domain of categorical input models, such as those used to model network traffic logs in order to perform anomaly detection for automated cybersecurity tools. More broadly, this problem is also relevant for large language models, and the associated concerns of adversarial input perturbation attacks against practical deployments of those.

To address the challenges due to adversarial attacks, adversarial training has been used to enhance the robustness of ML models against adversarial input attacks. Adversarial training involves augmenting training data for training the ML model with adversarial perturbed examples, forcing the ML model to learn more resilient decision boundaries.

To this end, the effectiveness of adversarial training heavily depends on quality and diversity of the adversarial examples in the training data used during the training process. Generating high-quality adversarial examples requires careful consideration of various factors, including the attack strategy, model architecture, and training objectives. Therefore, if adversarial examples in the training data do not correspond to various factors, the adversarial training of the ML model may result in suboptimal performance.

Accordingly, there is a need to provide a system and a method for defending against adversarial input attacks suitable for defending against adversarial perturbation of the discrete and/or categorial inputs.

### SUMMARY

It is an object of some embodiments to provide a system and a method for defending against adversarial input attacks. Additionally or alternatively, it is an object of some embodiments to provide a system and a method for defending against adversarial input attacks without a need to perform adversarial training. Additionally or alternatively, it is an object of some embodiments to provide a system and a method for defending against adversarial input attacks suitable for defending against adversarial perturbation of the discrete and/or categorial inputs. Such a method is referred herein as a robust transformation of the discrete and/or categorial inputs.

The present disclosure relates to a method, a system, and a computer program product for transformation of input data, such as to defend against adversarial input examples.

Some embodiments of the present disclosure are based on a recognition that discrete input allows for representation of categorical variables, which are prevalent in many real-world datasets. Examples of dataset relating to discrete input may include, but are not limited to, gender, ethnicity, product categories, sales data, number of employees, number of product reviews, and internet proxy data. Categorical variables play a crucial role in modelling relationships and patterns in data, especially in fields like marketing, demographics, and social sciences.

Some embodiments of the present disclosure are based on a recognition that generating adversarial examples from discrete input data poses several challenges compared to continuous input data due to the discrete, high-dimensional, and non-continuous nature of the input data.

Typically, generating adversarial examples for discrete input data involves creating small but targeted perturbations to input data samples in order to deceive the ML model trained on the input data samples. This process is particularly relevant in scenarios where the input data is categorical, symbolic, or discrete in nature (e.g., text, sequences, and categorical variables). Some embodiments of the present disclosure are based on a recognition that a number of general strategies may be used for generating adversarial examples for discrete input data. However, these strategies depend on a type of the discrete input data and thus fail to ensure optimal output of ML model trained on it.

To that end, it is an object of some embodiments to replace or at least complement adversarial training with robust transformations generated using randomized smoothing. Some embodiments are based on recognition that the robust transformation of input data suitable for defending against adversarial attacks can be performed with randomized smoothing of the input data. The basic idea in randomized smoothing is to add random noise to the input data of the ML model to drown out the small perturbation of an adversarial input attack. The input data is perturbed multiple times with independent noise samples, then the model is evaluated on each of these noised inputs, and the corresponding outputs are aggregated to produce a final model output. This aggregation of outputs across multiple samples of noise yields a result that represents an average model output over a local region of the original input data (such as, unperturbed image) that suppresses the effect of the small adversarial perturbation, which is effective only due to the specific direction of the perturbation. Further, the statistics of the multiple outputs can be analyzed to generate certified robustness guarantee.

However, a key limitation of randomized smoothing is that it is intended for addressing adversarial perturbations to data within a continuous input space (e.g., images, audio, video).

Hence, some embodiments of the present disclosure aim to adapt randomized smoothing to discrete input data by first embedding the discrete input into continuous space and applying the randomized smoothing in the embedded continuous space. Generating robust perturbed transformations of discrete input data in such manner allows to construct defense against adversarial attacks on the ML model expecting the discrete input data in a computationally efficient manner.

In addition, embodiments of the present disclosure are based on a recognition that unified adversarial training for different types of discrete input data may be performed by embedding the discrete input data into a continuous space, and introducing noise in the continuous space.

Accordingly, in one aspect, a computer-implemented artificial intelligence (AI) method for robust transformation of a discrete input with a neural network is provided. The neural network includes an embedding subnetwork and a transformation subnetwork. The method comprises embedding the discrete input into a continuous space using the embedding subnetwork to produce a continuous embedding. The method further comprises injecting a set of random noises of a predetermined magnitude into the continuous embedding to produce a set of perturbed embeddings. The method further comprises processing each of the set of perturbed embeddings with the transformation subnetwork to produce a set of transformations. The method further comprises outputting a combination of the set of transformations as the robust transformation of the discrete input.

According to additional embodiments, the discrete input includes a tensor of one or more categorical values.

According to additional embodiments, the discrete input is internet proxy log data.

According to additional embodiments, the continuous embedding includes a tensor of floating-point values.

According to additional embodiments, the set of random noises includes a set of Gaussian noise tensors. Each of the Gaussian noise tensors has a shape of the tensor of floating-point values and includes independent Gaussian samples having a mean of zero and a standard deviation defined by the predetermined magnitude.

According to additional embodiments, each of the perturbed embeddings is formed by adding the tensor of floating-point values to one of the Gaussian noise tensors.

According to additional embodiments, the transformation subnetwork is a deep neural network trained for one or a combination of: automatic speech recognition, language modelling, and log data modelling.

According to additional embodiments, the combination of the set of transformations is an aggregation of the set of transformations.

According to additional embodiments, each of the set of transformations is a continuous tensor, such that the robust transformation is determined as an average of the set of transformations.

According to additional embodiments, each of the set of transformations is a tensor of one or more vectors of logits. The method further comprises converting each of the one or more vectors of logits into a probability vector via a softmax operation to produce a set of probability vectors. The method further comprises averaging the set of probability vectors in a probability space to produce an average probability vector and determining the robust transformation of the discrete input using the average probability vector.

According to additional embodiments, the method further comprises converting the average probability vector with log-likelihoods to produce the robust transformation of the discrete input.

According to additional embodiments, each of the set of transformations is a tensor of one or more vectors of logits. The method further comprises converting each of the one or more vectors of logits into a hard decision by selecting an index of a largest logit value to produce a set of hard decisions and aggregating the set of hard decisions to produce the robust transformation of the discrete input.

According to additional embodiments, the neural network is trained with training samples of the discrete input.

According to additional embodiments, the neural network is trained with training samples of the discrete input modified with noise in the continuous space.

According to additional embodiments, to training the neural network, the method further comprises embedding a training sample of the discrete input with the embedding subnetwork into the continuous space to produce a training embedding. The method further comprises perturbing the training embedding multiple times with a random noise to produce a set of perturbed training embeddings and processing each of the set of perturbed training embeddings with the transformation subnetwork to produce a set of training transformations. The method further comprises combining the set of training transformations into a combined training output and updating parameters of the embedding subnetwork and the transformation subnetwork based on a loss function of the combined training output.

In another aspect, an artificial intelligence (AI) system for robust transformation of a discrete input with a neural network is provided. The neural network includes an embedding subnetwork and a transformation subnetwork. Further, the AI system includes a memory that stores instructions and a processor configured to execute the instructions to embed the discrete input into a continuous space using the embedding subnetwork to produce a continuous embedding, inject a set of random noises of a predetermined magnitude into the continuous embedding to produce a set of perturbed embeddings, process each of the set of perturbed embeddings using the transformation subnetwork to produce a set of transformations, and output a combination of the set of transformations as the robust transformation of the discrete input.

In yet another aspect, a non-transitory computer readable storage medium embodied thereon a program executable by a processor for performing a method for robust transformation of a discrete input with a neural network including an embedding subnetwork and a transformation subnetwork. The method comprises embedding the discrete input into a continuous space using the embedding subnetwork to produce a continuous embedding, injecting a set of random noises of a predetermined magnitude into the continuous embedding to produce a set of perturbed embeddings, processing each of the set of perturbed embeddings with the transformation subnetwork to produce a set of transformations, and outputting a combination of the set of transformations as the robust transformation of the discrete input.

### BRIEF DESCRIPTION OF DRAWINGS

The presently disclosed embodiments will be further explained with reference to the attached drawings. The drawings shown are not necessarily to scale, with emphasis instead generally being placed upon illustrating the principles of the presently disclosed embodiments.

FIG. 1 illustrates a block diagram of a network environment in which an artificial intelligence (AI) system for outputting a transformation of a discrete input is implemented, in accordance with some example embodiments of the present disclosure.

FIG. 2 illustrates a schematic diagram of operations of the AI system, in accordance with some example embodiments of the present disclosure.

FIG. 3 is a block diagram illustrating an operation of the AI system for generating a transformation of a tensor of categorical values, in accordance with some example embodiments of the present disclosure.

FIG. 4A, FIG. 4B and FIG. 4C depict schematic diagram of aggregation of the set of transformations to produce the transformation of the discrete input, in accordance with various example embodiments of the present disclosure.

FIG. 5 illustrates a flowchart of a method for training a neural network of the AI system, in accordance with some example embodiments of the present disclosure.

FIG. 6 illustrates a block diagram for adversarial attack detection with adversarial training, in accordance with some example embodiments of the present disclosure.

FIG. 7A and FIG. 7B illustrate exemplary discrete input as internet proxy log data, in accordance with some example embodiments of the present disclosure.

FIG. 8 illustrates a flowchart of a computer-implemented AI method for generating transformation of the discrete input, in accordance with some example embodiments of the present disclosure.

FIG. 9 illustrates a block diagram of a computer-based AI system for generating transformation of the discrete input, in accordance with an example embodiment.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without specific details. In other instances, systems and methods are shown in block diagram form only in order to avoid obscuring the present disclosure.

Throughout the present disclosure, the term “AI system” refers to a computer-based system or software that exhibits characteristics commonly associated with human intelligence. The AI system is designed to perform tasks that typically require human intelligence, such as problem-solving, learning, reasoning, perception, understanding natural language, and decision-making. AI systems can range from simple rule-based programs to sophisticated, self-learning systems.

Pursuant to present disclosure, the AI system may be a sophisticated piece of software that leverages a neural network for generating transformations of discrete input. Such transformations are used to create defense against adversarial attacks.

Typically, traditional means of providing cybersecurity demands a huge amount of human effort to monitor computer networks for potential intrusions/attacks and to address such threats with subsequent actions. To overcome this, AI-assisted anomaly detection techniques are utilized that are based on data-driven ML models. Some embodiments are based on an understanding that intrusions/attacks produce anomalies in measured network traffic data. These can be detected by ML-based anomaly detection methods, which provide the benefit of automation and reduced human labor.

However, there may exist a possibility for an advanced adversary that may specifically adjust their malicious attack behavior to both evade such ML-based anomaly detection methods and still achieve their original nefarious objectives. This is particularly a concern with modern ML-based anomaly detection methods, such as neural networks.

Some embodiments are based on a recognition that neural networks are susceptible to adversarial input perturbations, which are a family of attacks that produce carefully crafted perturbations to inputs of a neural network that can be both imperceptibly small and arbitrarily modify the output behavior of the neural network towards arbitrary nefarious aims.

Some embodiments are based on a recognition that adversarial examples may be used to train ML models. For example, adversarial examples are inputs that are slightly, but intentionally, perturbed to create a new example that can be misclassified by a ML model, such as a neural network. However, generation of high-quality adversarial examples is challenging, especially for discrete input data. Further, failure in generating high-quality adversarial examples may affect performance of the ML model that is trained on them.

Some embodiments of the present disclosure are based on a class of techniques known as randomized smoothing. The randomized smoothing techniques are used to add random noise to an input of an ML model to drown out small perturbation of an adversarial input attack. In an example, given the input, instead of directly classifying it, randomized smoothing adds a random perturbation to the input. This perturbation may be noise, or other types of randomness added to input data. The input is perturbed multiple times with independent noise samples, then the ML model is evaluated on each of the produced noise-induced inputs. Thereafter, outputs of the ML model for the corresponding noise-induced inputs are aggregated to produce a final model output. This aggregation of outputs across multiple samples of noise yields a result that represents an average model output over a local region of the original input that suppresses the effect of the small adversarial perturbation, which is effective only due to the specific direction of the perturbation. Further, the statistics of the multiple outputs may be analyzed to generate a robustness score or a certified robustness guarantee for the ML model.

Randomized smoothing helps in generating robust transformations by making it more difficult for an attacker to craft inputs that can consistently fool the ML model. The added randomness makes it harder for the attacker to anticipate the effect of their perturbations, thus increasing the robustness of the ML model against adversarial attacks.

With regard to anomaly detection, the ML model becomes less sensitive to small deviations or outliers that might otherwise trigger false alarms in anomaly detection systems by incorporating randomness into the classification process. This may lead to more reliable anomaly detection by reducing the likelihood of false positives while maintaining the ability to accurately detect genuine anomalies.

However, a key limitation of existing techniques, such as the randomized smoothing technique, is that they are intended for addressing adversarial perturbations to data or input within a continuous input space (e.g., images, audio, video).

In order to train the ML model for robust transformation, small perturbations to discrete input samples are created in order to deceive a ML model trained on that discrete input data. For example, the discrete input data may be categorical, symbolic, or discrete in nature. Examples of such discrete input data may include, but are not limited to, text sequences, and categorical variables.

In computer vision, transformations may be constructed or generated by considering a continuous space of imperceptible perturbations around, for example, image pixels. Conversely, language is discrete, and any perturbation is perceptible. Thus, robust models must be invariant to input modifications that preserve semantics, such as synonym substitutions, paraphrasing, or typos. For example, in sentiment analysis, it is common to consider the space of all synonym substitutions.

Some embodiments are based on recognizing that unified adversarial training for generating robust transformations from different types of discrete input data may be performed by embedding the discrete input data into a continuous space. Subsequently, an ML model or a neural network may be trained to be more robust against adversarial input attacks by generating robust transformations using randomized smoothing.

### Overview of AI System

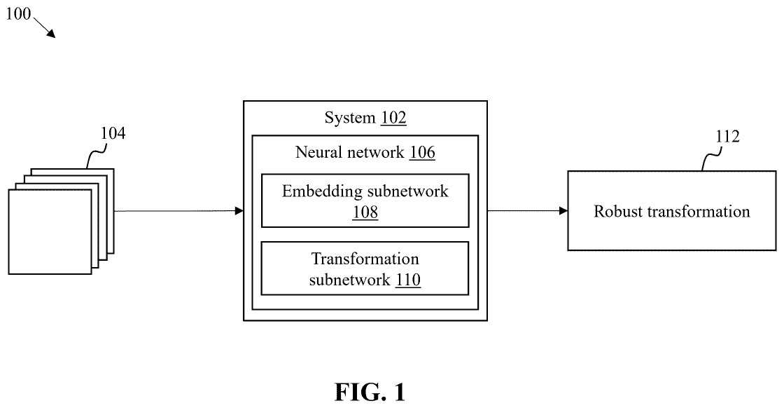

FIG. 1 illustrates a block diagram 100 of a system 102 in which a neural network 106 is configured to perform or generate robust transformation, according to some example embodiments of the present disclosure. The system 102 refers to a machine or a computation system that is configured to simulate human intelligence processes to perform tasks, such as natural language processing, speech recognition, process automation, robotics, machine vision, etc. In an example, the system 102 is configured to perform the robust transformation for a ML model, for example, the neural network 106, by using discrete input. In particular, the neural network 106 is configured to develop improved defense against adversarial input attacks by performing robust transformations for discrete input 104.

The system 102 includes the neural network 106. The neural network 106 may be a class of machine learning models. For example, the neural network 106 may include interconnected layers of artificial neurons, also known as nodes or units, organized in a hierarchical fashion. Each node may be configured to receive input signals, process them through an activation function, and produce an output signal that is transmitted to another node in a next layer. Further, the different layers of the neural network 106 may include an input layer, hidden layers, and an output layer. In particular, the input layer receives raw input data, such as the discrete input 104. Examples of the input data may include, but are not limited to, images, text, numerical values, etc. Further, each node of the input layer represents a feature or a dimension of the discrete input 104. Thereafter, the features of the discrete input 104 are passed from nodes of the input layer to nodes of the hidden layers. The hidden layers may be intermediate layers between the input layer and the output layer. The hidden layers may perform computations on the discrete input 104 through weighted connections between the nodes of the hidden layers. Further, after processing through the hidden layers, the nodes of the hidden layers may pass the processed output to nodes of the output layer. The output layer produces final predictions or outputs of the neural network 106.

It may be noted that each connection between the nodes of the layers is associated with a weight, which determines a strength of the connection. Additionally, each node may also have an associated bias term that is added to a weighted sum of inputs before applying an activation function. The activation functions introduce non-linearity into the neural network, enabling it to learn complex relationships in the data. Common activation functions include sigmoid, tanh, ReLU (Rectified Linear Unit), and softmax.

Pursuant to present disclosure, the discrete input 104 refers to data that may only take on a finite set of distinct values. Examples of the discrete input 104 include categorical variables (e.g., gender, color, internet proxy data), text (sequences of words or characters), and discrete features in structured data.

Typically, adversarial attacks on discrete input involve modifying values of discrete features or changing a structure of the discrete input data to induce misclassification or erroneous behavior in the model.

According to the present disclosure, the neural network 106 utilizes an embedding subnetwork 108 and a transformation subnetwork 110 (collectively referred to as subnetworks 108 and 110) to generate robust transformation 112 of the discrete input 104. In an example, the subnetworks 108 and 110 are also neural networks, for example, a subset or a part of an entire architecture of the neural network 106. In particular, each of the subnetworks 108 and 110 may represent a modular component of the overall architecture of the neural network 106. For example, each of the subnetworks 108 and 110 may have specific functionalities or characteristics associated with an operation of the neural network 106.

The system 102 of the present disclosure applies randomized embedding smoothing to the neural network 106 to generate or perform robust transformation 112 for the discrete input 104. Such a robust transformation 112 can be used for training the neural network 106 and/or for the execution of the neural network 106.

In an example, the neural network 106 may be used for log data anomaly detection that may receive the discrete input 104. For example, the discrete input 104 may be categorical variables and/or tokens.

In operation, the system 102 is configured to generate embeddings of the discrete input 104 in a continuous space using the embedding subnetwork 108. Further, the system 102 is configured to inject noise at the embedding subnetwork or in an embedding layer across multiple, independent samples of noise. Further, a final output corresponding to the discrete input 104 is produced by aggregating model outputs from processing the corresponding noised inputs.

In this regard, randomized input smoothing is performed such that noise injection and aggregation across multiple samples may curtail an impact of an adversarial input perturbation. Further, generalizing this to randomized embedding smoothing makes it applicable to discrete input 104 that may be fed to discrete input models with an input embedding layer. In an example, a performance of the defense of the neural network 106 may be further enhanced by training or tuning the neural network 106 to regularize the embedding subnetwork.

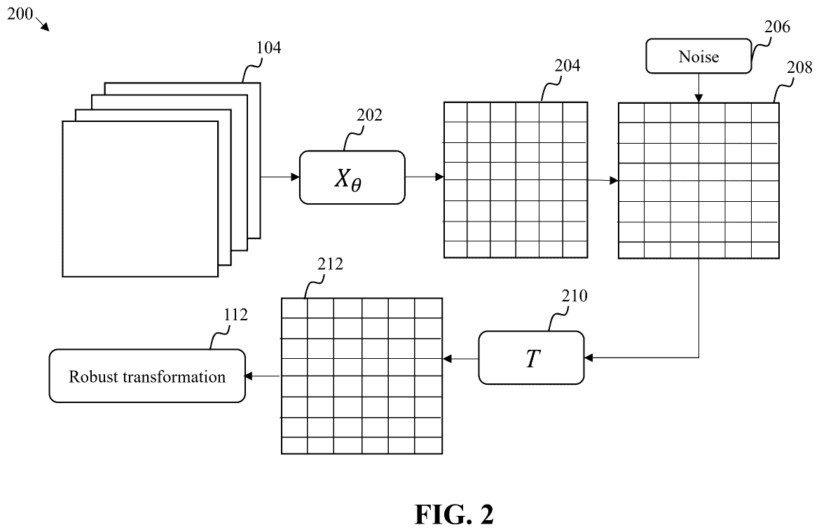

FIG. 2 illustrates a schematic diagram 200 of operations of the AI system 102, according to some example embodiments. FIG. 2 is described in conjunction with FIG. 1.

The AI system 102 is configured to receive the discrete input 104. Such discrete input data may be received from various sources depending on a nature of a task and a domain of the neural network 106. Some common sources of discrete input may include, but are not limited to, categorial variables, text data, sparse data representations, categorical features in structured data, symbolical data, and event-based data.

In an example, the discrete input 104 may be received from categorical variables. For example, datasets including categorical variables may include discrete variables that represent categories or groups. These variables may include attributes such as gender, ethnicity, product type, customer segment, etc. The neural network 106 may receive the discrete input 104 directly from the categorical variables encoded as numerical values or one-hot encoded vectors.

In another example, the discrete input 104 may be received from text data sources. For example, as text data is inherently discrete, the text data may include sequences of discrete symbols such as characters or words. For example, the neural network 106 may be associated with natural language processing (NLP) tasks, such as sentiment analysis, machine translation, or text classification. Subsequently, the neural network 106 or the system 102 may receive discrete input 104 as text data. Each word or character in the text data may be represented as a discrete token, that may be encoded using techniques like word embeddings or character embeddings.

In yet another example, the discrete input 104 may be received from symbolic data sources. For example, the neural network 106 or the system 102 may receive discrete input 104 in the form of symbols, logical predicates, or symbolic representations of concepts and relationships. Such discrete input 104 may be received for tasks relating to expert systems, knowledge graphs, and symbolic reasoning.

Further, the system 102 is configured to embed the discrete input 104 into a continuous space using the embedding subnetwork 108 to produce a continuous embedding 204. Typically, embedding is a method of mapping high-dimensional data, such as the discrete input 104 to a low-dimensional space, such as the continuous embedding 204. This may be used to transform non-continuous discrete input 104 into continuous vector representations for computer processing.

In an example, the embedding subnetwork 108 may include an embedding layer 202, X_{θ}. In an example, the embedding subnetwork 108 may be configured to represent each discrete value of the discrete input 104 as a binary vector where all elements are zero except for the one corresponding to the value's index. For example, for a categorical variable with three possible values, each of the values may be encoded as a vector of length three. Once encoded, each of the vectors of the discrete input 104 may be passed through the embedding layer 202 in embedding neural network or the embedding subnetwork 108. The embedding layer 202 may map each of the encoded vector to map the encoded vector to a continuous vector representation, also known as an embedding. The embedding layer 202 may be a lookup table X_{θ}, where each row corresponds to a unique discrete value, and the embedding subnetwork 108 learns to update the values in the lookup table during training to optimize the embedding task.

In accordance with an example, the embedding subnetwork 108 may be pre-trained word embeddings like Word2Vec, GloVe, or FastText, which have been trained on large corpora of text data and provide pre-trained embeddings for a vast vocabulary. These pre-trained embedding subnetwork 108 may capture semantic relationships between words and may be fine-tuned for specific tasks.

Once embedded into a continuous space, the discrete input 104 may be visualized and interpreted using techniques such as scatter plots, heatmaps, or clustering algorithms. These visualizations may provide insights into the relationships between different discrete values and how they are represented in the continuous space.

Further, the system 102 is configured to inject a set of random noises 206 of a predetermined magnitude into the continuous embedding 204 to produce a set of perturbed embeddings 208. Injecting the set of random noises 206 into the continuous embedding 204 is beneficial for improving the robustness and generalization of the neural network 106.

In one example, the set of random noises 206 may be gaussian noise sampled from a normal distribution. Further, a magnitude of the gaussian noise may be controlled or adjusted to the predetermined magnitude by adjusting a standard deviation of the normal distribution. Such gaussian noise introduces random perturbations to the embedding vectors of the continuous embedding 204. In another example, the set of random noises 206 may be adversarial noise that may be carefully crafted to maximize a loss function of the neural network 106 while remaining imperceptible. In yet another example, the set of random noises 206 may be random perturbations that may be added to the continuous embedding vectors by adding small, random offsets to each dimension of the continuous embedding 204.

In certain other cases, the set of random noises 206 may be added or injected to the continuous embedding 204 using dropout regularization, data augmentation, or gradient masking. For example, the dropout regularization may cause to randomly set a fraction of elements in the continuous embedding 204 vectors to zero, effectively introducing noise. Moreover, the data augmentation may introduce random transformations to the continuous embedding vectors by, for example, rotations, translations, or scaling. In addition, the gradient masking intentionally masks or manipulates gradients of continuous embedding vectors.

The injection of the set of random noises 206 may modify the embedding vectors of the continuous embedding 204 in a way that makes the vectors slightly different from their original representations. This allows the set of perturbed embeddings 208 to defend against an adversarial input attack by essentially drowning those small adversarial perturbations with random noise.

The system 102 is configured to process each of the set of perturbed embeddings 208 with the transformation subnetwork 110 to produce a set of transformations 212. It may be noted, the set of perturbed embeddings 208 refers to embeddings that have been intentionally modified or distorted from their original representations, i.e., modified or transformed from the continuous embedding 204. The modifications are introduced as a form of the set of random noise 206.

In accordance with an embodiment, the transformation subnetwork 110 is a deep neural network trained for one or a combination of: automatic speech recognition, language modelling, and log data modelling. For example, the transformation subnetwork 110 may be a transformer-based model having the ability to capture long-range dependencies and contextual information effectively. The transformation subnetwork 110 may be used for performing several tasks, such as modifying input, i.e., the set of perturbed embeddings 208, to draw conclusions and/or generate outputs. Examples of the tasks that may be performed by the transformation subnetwork 110 may include, but are not limited to, language modeling, machine translation, speech recognition, text generation, question answering, text classification, named entity recognition, and summarization.

To this end, the set of perturbed embeddings 208 may be transformed into the set of transformations 212 based on a transformation task 210 associated with the transformation subnetwork 110. The transformation task 210 may indicate a function or a type of transformation to be performed on the set of perturbed embeddings 208 in order to carry out a task associated with the transformation subnetwork 110 or the neural network 106.

Further, the system 102 is configured to output a combination of the set of transformations 212 as the robust transformation 112 of the discrete input 104. In an example, the combination of the set of transformations 212 is an aggregation of the set of transformations 212. In another example, randomly selected transformations from the set of transformations 212 may be aggregated to generate the output. The output may be the robust transformation 112 that may form the defense of the neural network 106 and enable the neural network 106 to provide robust output, i.e., perform tasks accurately even with slight perturbations. For example, for an anomaly detection-based neural network 106, the neural network 106 robustly or reliably detects anomaly even when perturbed input may be provided.

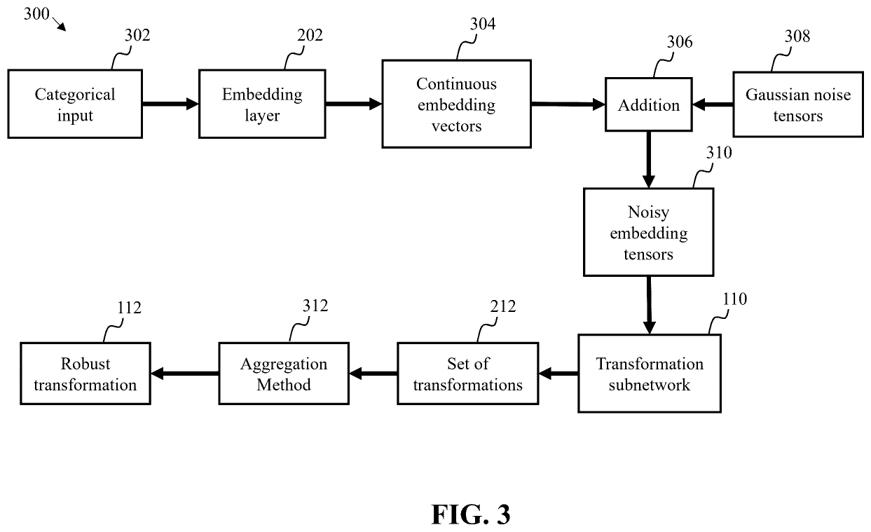

FIG. 3 is a block diagram 300 illustrating an operation of the system 102 for generating adversarial transformation of a tensor of categorical values, according to some embodiments of the present disclosure. FIG. 3 is described in conjunction with FIG. 1 and FIG. 2.

In an example, the system 102 may receive the discrete input 104. In an example, the discrete input 104 may include a tensor of one or more categorical values. Such tensor of one or more categorical values is referred to as a categorical input 302. In another example, the discrete input 104 may correspond to internet proxy log data. The internet proxy log data refers to records of activity logged by a proxy server as it handles requests from clients, such as web browsers or other applications to access resources on the internet. In particular, the categorial input 302 may correspond to, for example, natural language or log data. Subsequently, the system 102 or the neural network 106 may be a language model or a log data processing model.

In an example, the continuous embedding 204 includes a tensor of floating-point values. For example, the tensor of continuous embedding 204 may be a multi-dimensional array that contains continuous-valued embeddings for various entities, such as words, phrases, or entities in a dataset or the discrete input 104. The continuous embedding 204 may be dense, low-dimensional representations of the discrete categorial input 302 that captures semantic relationships and contextual information. The tensor of the continuous embedding 204 may store numerical representations of entities in a dense vector format. Each entity may be represented by a fixed-size vector, where each element of the vector corresponds to a numerical value. Further, the floating-point values in the tensor of the continuous embedding 204 may represent real numbers, such as floating-point numbers. These real numbers are used to represent embedding components (or numerical components) of the continuous embedding vectors 304. The floating-point values may be real numbers that are stored in the tensor to represent the learned embeddings for various entities (such as words, phrases, or entities) in the categorial input 302.

According to the embodiments of the present disclosure, noise perturbations are injected or added 306 to the continuous embedding vectors 304. In this regard, the set of random noises 206 may be added to the continuous embedding vectors 304. In an example, the set of random noises 206 includes a set of Gaussian noise tensors. The set of Gaussian noise tensors are tensors that include random noise sampled from a Gaussian (normal) distribution. Gaussian noise is a type of statistical noise characterized by its probability density function, which follows a bell-shaped curve known as the Gaussian distribution. For example, each of the Gaussian noise tensors has a shape of the tensor having the floating-point values. In an example, a number of dimensions of each of the Gaussian noise tensors is called its rank and a length in each dimension describes its shape. Further, the shape of the Gaussian noise tensors may be indicated by the floating point values, i.e., a real number and a decimal part, of the tensor of the continuous embedding 204. Each of the Gaussian noise tensors may also include independent Gaussian samples having a mean of zero and a standard deviation defined by the predetermined magnitude.

In an example, the floating-point values of the tensor of the continuous embedding 204 represent a magnitude of tensor elements of the continuous embedding vectors 304. When Gaussian noise tensors are added to the continuous embedding vectors 304, individual elements of the tensors of the continuous embedding vectors 304 are modified by adding or subtracting the predetermined magnitude to floating-point values of the tensor of the continuous embedding 204. For example, the floating-point values are sampled from the sampled from a specified distribution, such as a Gaussian distribution of the continuous embedding 204 or the continuous embedding vectors 304. Moreover, Gaussian samples in Gaussian noise tensors may have a specified mean, i.e., zero, and standard deviation, i.e., the predetermined magnitude.

For example, based on adding or subtracting the floating-point values of the tensor of the continuous embedding 204 to Gaussian noise tensors, the set of perturbed embeddings 208 is produced. In an example, a perturbed embedding from the set of perturbed embeddings 208 is formed by adding a tensor of floating-point values of a corresponding continuous embedding vector to one of the set of Gaussian noise tensors. In other cases, each of the set of perturbed embeddings 208 is formed by performing another mathematical operation, such as average, subtracting, dividing, multiplying, etc. on the tensor of floating-point values of the continuous embedding vectors 304 and the Gaussian noise tensors.

In operation, the categorical input 302, denoted by X, is received. In an example, the categorical input 302 may be a tensor of one or more categorical values. Further, the categorical input 302, X, may be fed to the embedding subnetwork 108 to produce the continuous embedding vectors 304, W. The continuous embedding vectors 304, W, may be a tensor of one or more embedding vectors that consists of continuous (i.e., floating-point) values. In other words, the continuous embedding vectors 304 may be the tensor of floating-point values.

Further, the set of random noises 206 are generated. In an example, the set of random noises 206 may be generated as k independent sets of Gaussian noise tensors 308. For example, the sets of Gaussian noise tensors 308 may be denoted as Z₁, . . . , Zₖ, where each Zᵢ is of a same shape as the tensor of continuous embedding vectors 304, W. Moreover, each Zᵢ may include independent Gaussian samples that have a mean of zero and standard deviation of σ. The values of k and θ are hyperparameters.

In an example, the tensor of the continuous embedding vectors 304 are added 306 to the each of the set of Gaussian noise tensors 308, Z₁, . . . , Zₖ, to produce the set of perturbed embeddings 208. The set of perturbed embeddings 208 may be represented as noisy embedding tensors 310. The noisy embedding tensors 310 may be denoted as, \tilde{W}ᵢ=W+Zᵢ for i=1, . . . , k.

Thereafter, the noisy embedding tensors 310 are fed to the transformation subnetwork 110. In an example, the transformation subnetwork 110 may include model layers that are applied to each of the noisy embedding tensors 310, \tilde{W}₁, . . . , \tilde{W}ₖ. For example, the model layers of the transformation subnetwork 110 may be hidden layers of the neural network 106. The model layers or the transformation subnetwork 110 may be configured to perform processing and transform input data, i.e., the noisy embedding tensors 310, as it passes through the transformation subnetwork 110. In an example, each model layer of the transformation subnetwork 110 may perform specific computations on the noisy embedding tensors 310 and may introduce non-linearity into operations of the transformation subnetwork 110. For example, the model layers of the transformation subnetwork 110 may include an input layer for receiving the noisy embedding tensors 310, hidden layers for processing the noisy embedding tensors 310, and an output layer to produce a set of transformations 212, Y₁, . . . , Yₖ. In this manner, the layers of the transformation subnetwork 110 may transform the noisy embedding tensors 310 to produce the set of transformations 212. In an example, each of the set of transformations 212 may correspond to a noisy embedding tensor from the noisy embedding tensors 310. For example, different embedding tensors may be transformed differently to produce the set of transformations 212.

In an example, an aggregation method 312 may be applied on the set of transformations 212 to produce a final model output, i.e., the robust transformation 112. For example, the robust transformation 112 may be a combination of the set of transformations 212. In an example, an aggregation of each of the set of transformations 212 is performed to produce the final robust transformation 112. Alternatively, an aggregation of randomly selected outputs or transformations from the set of transformations 212 may be performed to produce the final robust transformation 112.

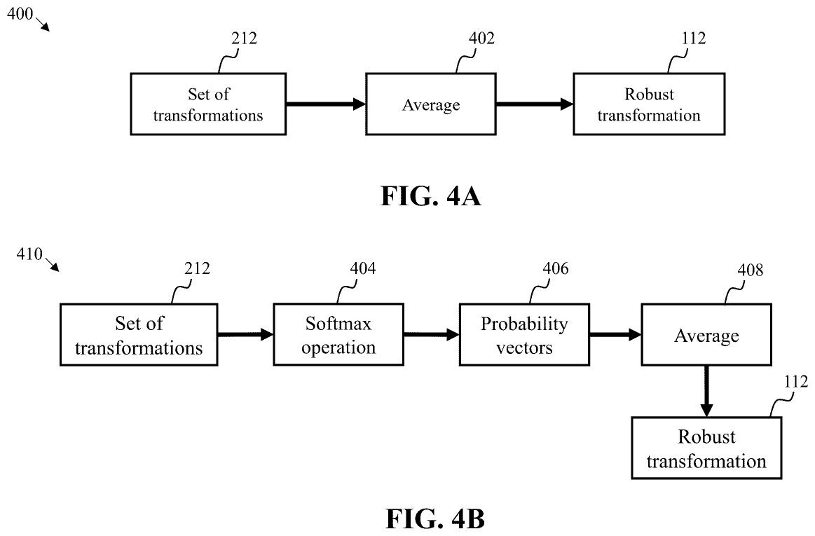

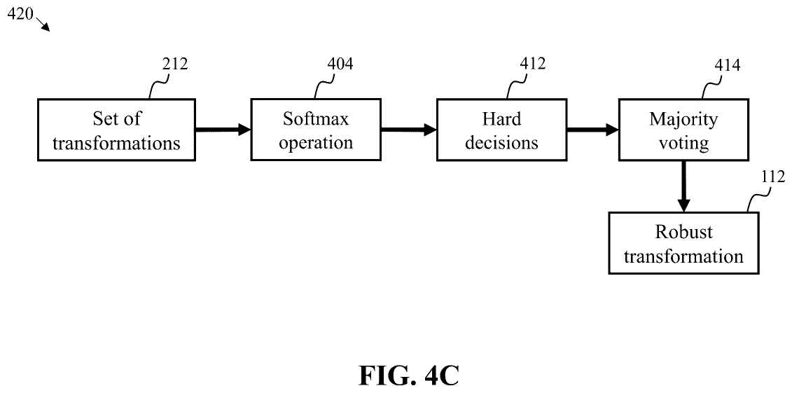

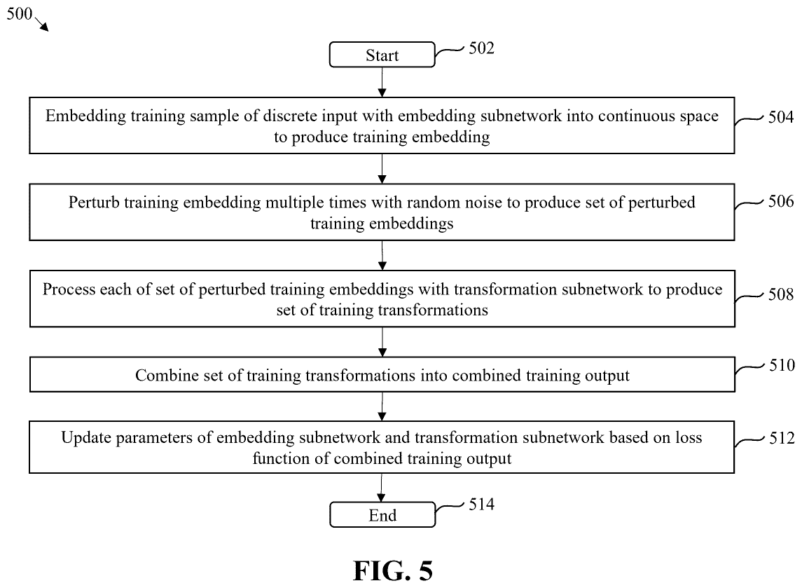

For example, the aggregation method 312 may aggregate the set of transformations 212, Y₁, . . . , Yₖ, into the final robust transformation 112, denoted by Y. An exact nature of the aggregation may vary and may depend on a nature of the set of transformations 212 of the transformation subnetwork 110. Details of aggregation of the set of transformations 212 to produce the final robust transformation 112 are described in conjunction with FIG. 4A, FIG. 4B and FIG. 5.

### Overview of Producing Robust Transformation from Set of Transformations

FIG. 4A is a schematic diagram 400 of aggregation of the set of transformations 212, according to some example embodiments. FIG. 4A is explained in conjunction with FIG. 1, FIG. 2, and FIG. 3.

In particular, the aggregation method 312 may be used to aggregate the set of transformations 212 to produce the final robust transformation 112. According to present example, the aggregation method 312 may correspond to computing an average 402 for the set of transformations 212. For example, each of the set of transformations 212, Y₁, . . . , Yₖ, may include a continuous tensor. Further, the final output or the robust transformation 112, Y, may be the robust transformation of the categorical input 302. The robust transformation 112 may be determined as an average 402 of the set of transformations 212.

FIG. 4B is a schematic diagram 410 of aggregation of the set of transformations 212, according to some example embodiments. FIG. 4B is explained in conjunction with FIG. 1, FIG. 2, FIG. 3, and FIG. 4A.

In particular, the aggregation method 312 may be used to aggregate the set of transformations 212 to produce the final robust transformation 112.

The present example is based on a recognition that each of the set of transformations 212 may be a tensor of one or more vectors of logits. The logits may be raw and unnormalized predictions produced by the transformation subnetwork 110 before applying any activation function. Logits may be an output of a last layer, such as an output layer of the transformation subnetwork 110, just before passing through the activation function. In an example, each transformation, Yᵢ, of the set of transformations 212, Y₁, . . . , Yₖ, is a tensor of one or more vectors of logits, i.e., unnormalized log-likelihoods.

In an example, given a set of logits z=z₁, z₂, . . . , zₙ, where n is a number of classes, a probability vector of each class i may be calculated using a Softmax operation 404 as:

$$P ( {y}_{i} ) = \frac{{e}^{{z}_{i}}}{{\sum }_{j = 1}^{n} {e}^{{z}_{j}}}$$

where:
zᵢ is a logit corresponding to class i, P(yᵢ) is the probability vector of class i, and e is Euler's number.

In operation, the system 102 may be configured to convert tensor of each of the one or more vectors of logits of the set of transformations 212 into a probability vector via the softmax operation 404 to produce a set of probability vectors 406. The one or more vectors of logits may be a collection of vectors for each of the set of transformations 212 of the categorical input 302. The vectors of logits may be used to compute the set of probability vectors 406 for the set of transformations 212 in parallel using the softmax operation 404. For example, each logit vector of the set of transformations 212 is converted into a probability vector via the softmax operation 404. Pursuant to present example, the softmax operation 404 may exponentiate each term and normalize across each vector such that a vector sum that is equal to one, i.e., a probability distribution over the vectors of the set of transformations 212.

Thereafter, the system 102 may be configured to aggregate the set of transformations 212 by computing an average 408 of the set of probability vectors 406 in a probability space. In an example, the aggregation method 312 may be utilized to compute the average 408 of the set of probability vectors 406 in the probability space. In this manner, the set of probability vectors 406 are aggregated by averaging 408 to produce an average probability vector. For example, the averaging 408 is performed across the probability distribution of the vectors of logits of the set of transformations 212 or the set of probability vectors 406.

The system 102 may be configured to convert the average probability vector with log-likelihoods to produce the robust transformation of the discrete input 104. Subsequently, the robust transformation 112 of the discrete input 104 or the categorical input 302 is determined using the average probability vector.

FIG. 4C is a schematic diagram 420 of aggregation of the set of transformations 212, according to some example embodiments. FIG. 4C is explained in conjunction with FIG. 1, FIG. 2, FIG. 3, FIG. 4A and FIG. 4B.

In an example, each transformation, Yᵢ, of the set of transformations 212 may be a tensor of one or more vectors of logits or probabilities. In this regard, the aggregation method 312 may be based on hard decisions. The hard decisions refer to a process of selecting a vector with a highest probability as a predicted vector for aggregation.

In an embodiment, the system 102 may be configured to convert each of the one or more vectors of logits into a hard decision by selecting an index of a largest logit value to produce a set of hard decisions 412. In particular, after applying the softmax operation 404 to the vectors of the logits, i.e., raw predictions or outputs produced by the transformation subnetwork 110, a probability distribution over the vectors is generated. The probability distribution may include the set of probability vectors 406 in a probability space, where each vector is assigned a probability score between 0 and 1. To generate the set of hard decisions 412, the vector with the highest probability or logit value is chosen as the predicted vector. In an example, each vector of the logits of the set of transformations 212 may be converted to a hard decision to generate the set of hard decisions 412 by taking the index of the maximum logits value, such as by applying argmax operation in each logit or the set of probability vectors 406.

Thereafter, the system 102 is configured to aggregate the set of hard decisions 412 to produce the robust transformation 112 of the discrete input 104. In this regard, the aggregation method 312 may involve aggregating the set of hard decisions 412 across the samples by taking a mode, i.e., majority voting 414 across each of the set of hard decisions 412 to produce the final model output or the robust transformation 112, Y, for the categorical input 302.

### Overview of Training

FIG. 5 illustrates a flowchart of a method 500 for training the neural network 106 of the AI system 102, in accordance with some example embodiments of the present disclosure. FIG. 5 is explained in conjunction with FIG. 1, FIG. 2, FIG. 3, FIG. 4A, FIG. 4B, and FIG. 4C.

While the above techniques described in conjunction with FIG. 1, FIG. 2, FIG. 3, FIG. 4A, FIG. 4B, and FIG. 4C may be applied to a trained neural network 106, without any further modification besides injecting noise. For example, a performance of the system 102 may be improved by modifying the neural network 106 by adjusting a training procedure used to produce the neural network 106. In an example, the training method 500 of the present example may be applied on a pretrained neural network, and thus the method 500 could be applied while fine-tuning the neural network to generate transformations of discrete input. Alternatively, the training method 500 may be applied when the neural network 106 is trained from scratch.

The training method starts at 502.

At 504, a training sample of a discrete input is embedded with the embedding subnetwork 108 into a continuous space to produce a training embedding. In an example, the system 102 is configured to embed the training sample of the discrete input 104 into the continuous space. The neural network 106 is trained with the training sample of the discrete input 104 to learn to generate a transformation for the training sample. In an example, the embedding of the training sample in the continuous space may be a dense, low-dimensional vector representation of the training samples, such as words, phrases, or entities, mapped into a continuous vector space. The embeddings of the training samples may be generated using techniques, such as word2vec, GloVe or embeddings layers in deep learning models (e.g., transformers).

In an example, during the training of the neural network 106, the training embedding generated by the embedding subnetwork 108 in the continuous space may be constrained to have a bounded or uniform norm. for example, the bounding may be achieved with hard structural constraints, or with soft constraints. In an example, a hard structural constraint may be set by introducing a normalization function upon the training embedding. Alternatively, a soft constraint may be set by introducing an additional regularization term to a training objective that aims to normalize the training embedding.

At 506, the training embedding is perturbed multiple times with a random noise to produce a set of perturbed training embeddings. In an example, the system 102 is configured to inject the random noise to the training embedding of the training samples in the continuous space. In an example, Gaussian noise may be injected into the training embedding in the embedding layer or the continuous space. The Gaussian noise may be applied once per training sample, i.e., augmenting embedding of each of the training samples with the Gaussian noise or the random noise. In another example, the multiple samples of the random noise may be added in parallel. In this regard, entire randomized embedding smoothing process, such as including aggregation across multiple outputs may be simulated during training. To this end, the set of perturbed training embeddings may be training embeddings of the training samples in the continuous space, such that each of the training embeddings is injected or augmented with a random noise or multiple samples of random noise.

At 508, each of the set of perturbed training embeddings is processed with the transformation subnetwork 110 to produce a set of training transformations. In an example, the transformation subnetwork 110 may be associated with a task, such as speech recognition, sentiment analysis, image classification, spam detection, named entity recognition, part-of-speech tagging, recommendation generation, sequence labeling, text classification, and topic modeling. To this end, the transformation subnetwork 110 is trained to generate transformations of input data and predict an output based on the task to be performed on the input data. Subsequently, the transformation subnetwork 110 may generate the output as the set of training transformations by processing the set of perturbed training embeddings. As the training embeddings are perturbed, i.e., augmented with noise, they may deviate from its original representation in the continuous space. Therefore, the set of training transformations that is generated based on the set of perturbed training embeddings may be adversarial to the training samples, i.e., may correspond to an adversarial task. Thus, the set of training transformations may aim to maximize the prediction error or misclassification of the neural network 106 while ensuring that the perturbation remains imperceptible.

At 510, the set of training transformations is combined into a combined training output. In an example, the system 102 may be configured to combine each of the set of training transformations using an aggregation method. For example, the aggregation method may rely on computing a sum, an average, an average of a probability distribution, or a majority value from a probability distribution of hard decisions of the set of training transformations.

At 512, parameters of the embedding subnetwork 108 and the transformation subnetwork 110 are updated based on a loss function of the combined training output. In an example, the loss function may indicate a difference between the predicted combined training output for the training samples and actual values (ground truth) of the training samples.

In this manner, the neural network 106 is trained with the training samples of the discrete input, such as the discrete input 104. In particular, the neural network 106 is trained with the training samples of the discrete input 104 modified with noise or the random noise in the continuous space. In this manner, the neural network 106 is trained to adapt to the presence of the random noise 206 added by defense method.

Once the embedding subnetwork 108 and the transformation subnetwork 110 are trained, the neural network 106 is used to generated the robust transformation 112 of the discrete input 104, such as the categorical input 302. A manner in which the robust transformation 112 is generated from the discrete input 104 is described in detail in conjunction with the FIG. 1, FIG. 2, FIG. 3, FIG. 4A, FIG. 4B and FIG. 4C.

The training method ends at 514.

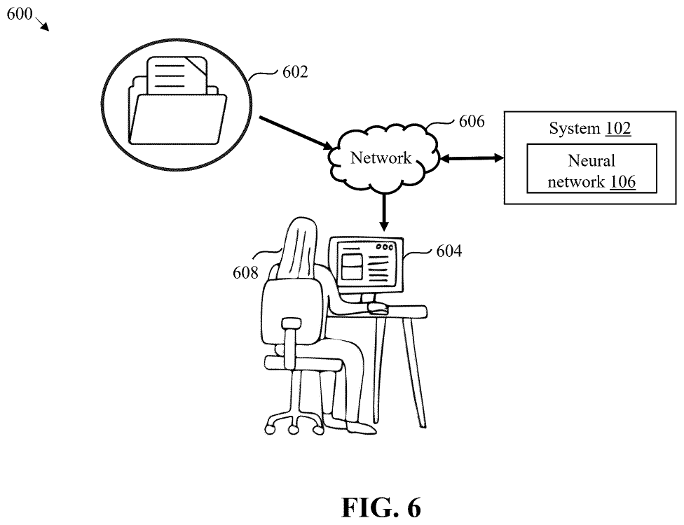

In an example embodiment, the neural network 106 is trained to build defense against adversarial attacks. In an example, the neural network 106 is trained with training data, such as the discrete input 104 augmented with adversarial examples produced through standard adversarial attacks, such as projected gradient descent, the fast sign gradient method, or other gradient based adversarial example generation methods. An example implementation of the system 102 comprising the neural network 106 trained to detect adversarial attack is described in conjunction with FIG. 6.

### Overview of Implementation

FIG. 6 illustrates a block diagram 600 for adversarial attack detection with adversarial training, in accordance with some example embodiments of the present disclosure.

In an example, the adversarial attack detection is performed for malware detection, where the goal is to classify software files, depicted as software file 602 as either benign or malicious based on their features. In cybersecurity, malware detection plays a crucial role in identifying and mitigating malicious software threats. Traditional machine learning models for malware detection may struggle to generalize well to new or previously unseen malware variants, especially when attackers intentionally craft adversarial samples to evade detection.

For example, attackers may exploit vulnerabilities in typical ML models by generating adversarial samples, which are modified versions of malware files designed to evade detection while maintaining their malicious functionality. Adversarial samples may contain subtle modifications that deceive the traditional ML model into misclassifying them as benign, posing a significant security risk.

In this regard, adversarial training may be employed to enhance the robustness of malware detection models, such as the neural network 106 against adversarial attacks.

As described in the present disclosure, the system 102 is configured to defend against adversarial attacks by generating or performing the robust transformation 112 of the discrete input 104. In particular, the system 102 is configured to utilize the embedding subnetwork 108 to embed the discrete input 104 into a continuous space. Further, noise is added to the embedding of the discrete input in the continuous space. In an example, once the noise is added, the transformation subnetwork 110 may perform its task-specific operations on the perturbed embeddings. In an example, the discrete input 104 may be related to malware files. Subsequently, the adversarial samples or examples are crafted by perturbing features of the malware files in a way that maximizes a loss function of the neural network 106 while ensuring that the perturbed features remain functionally similar to the original features.

Pursuant to the present example, the transformation subnetwork 110 may be associated with malware detection task for software files. Further, based on the generation of the transformations of the perturbed embeddings, an aggregation of the transformations may be performed to generate the robust transformation 112 of the discrete input 104. The generation of the robust transformation 112 or performing the robust transformation 112 for the discrete input 104 by introducing noise into the discrete input 014 and may enable the neural network to build defense mechanism against adversarial input.

To this end, the neural network 106 is trained to perform robust transformations of different types of discrete input, such as the robust transformation 112 of the discrete input 104. The neural network 106 may undergo adversarial training on both the original features of malware samples as well as robust transformation of the features of malware samples. Such adversarial training encourages the neural network 106 to learn robust feature representations that are less susceptible to adversarial perturbations. The neural network 106 learns to distinguish between genuine malware samples and adversarial samples and adjusts its decision boundaries, accordingly, improving its ability to detect both known and previously unseen malware variants.

Once trained, the system 102 and the neural network 106 may be deployed within a network 606 of a user 608. For example, when a user device 604 of the user 608 may receive the software file 602, then the system 102 or the neural network 106 may analyze the software file 602 to check for malicious content in the software file 602. In response to detecting malicious content in the software file 602, the user 608 may be alerted about the malicious content of the software file 602 and/or the software file 602 may be blocked for receival at the user device 604. Alternatively, if the software file 602 is found to be benevolent, then the software file 602 may be transferred to the user device 604.

Through adversarial training, the neural network 106 becomes more resilient to adversarial samples crafted by attackers, ensuring more accurate and reliable detection of malicious software threats. This enhances the security of the network 606 of organizations and helps protect against evolving cybersecurity threats in real-world scenarios.

### Overview of Exemplary Discrete Input

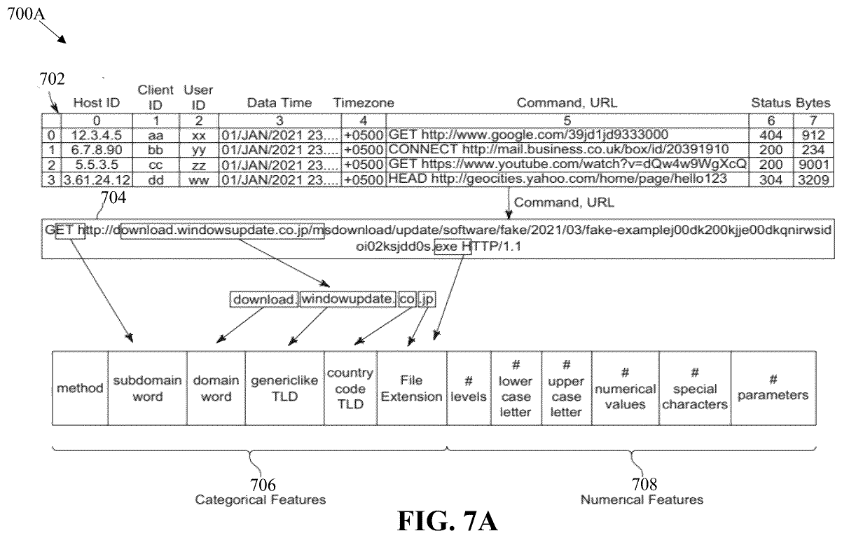

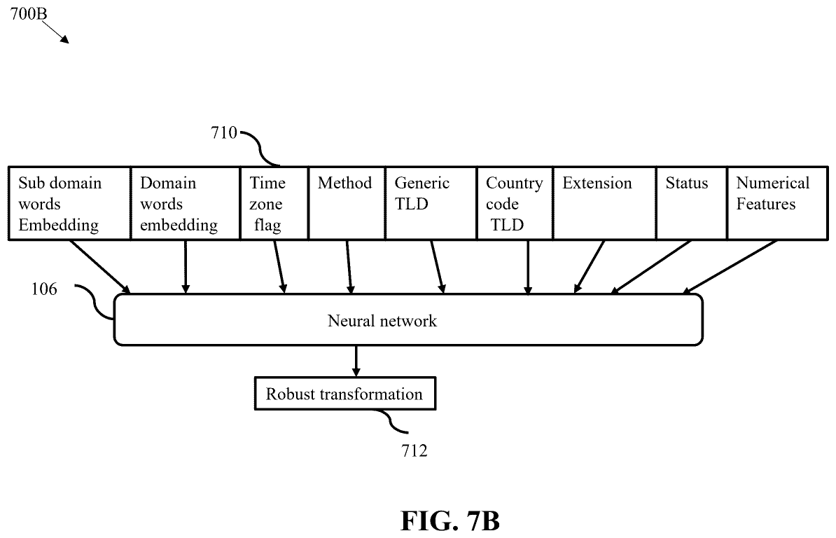

FIG. 7A and FIG. 7B illustrate exemplary discrete input as internet proxy log data, in accordance with some example embodiments of the present disclosure.

Referring to FIG. 7A, a schematic illustration 700A for exemplary discrete input as internet proxy log data is shown. The internet proxy log data 702 is decomposed into categorical features and numerical features. The internet proxy log data 702 comprises information associated with requests made by a user to a network. For example, the internet proxy log data 702 comprises host id, client id, and user id of the user that has requested the network to access a specific website or web content. The internet proxy log data 702 further comprises data time, time-zone, and command used by the user to access the specific website or the web content along with information about status of the command and number of bytes used by the command.

The internet proxy log data 702 is a raw data that comprises sequences of log entries of internet traffic requests from many different users, where these sequences of log entries are inherently interleaved in the internet proxy log data 702. Thus, in order to detect anomaly in the internet proxy log data 702, an anomaly detector neural network may have to first de-interleave the sequences of log entries generated by different users, and then handle each user's sequence independently. Further, simply processing all of the sequences while interleaved may overburden the neural network with additional unnecessary complexity.

A Uniform Resource Locator (URL) 704 corresponding to one of the de-interleaved sequences may be obtained by the anomaly detector, where the anomaly detector decomposes the URL 704 into a plurality of parts based on the plurality of features comprised in the URL 704. The URL 704 comprises different information associated with the request made by the user to access the website or the web content. The information comprised by the URL 704 is decomposed into categorical features 706 and numerical features 708. The information decomposed into the categorical features 706 comprises method name used by the user to access the website, in this case method name corresponds to “GET”, where GET is a default HTTP method that is used to retrieve resources from a particular URL. The information comprised in the categorical features 708 further includes sub-domain words, in this case “download”; domain words, in this case “windowsupdate.”; generic-like top-level domain (TLD): “co.”; country code TLD: “.jp”; and file extension: “.exe”. The subdomain word and domain word may be further categorized into embedded features due to the very large word vocabulary sizes.

Further, information of the URL 704 categorized into numerical features 708 comprises number (#) of levels, #of lowercase letters, #of uppercase letters, #of numerical values, #of special characters, and #of parameters. The data corresponding to each feature is vectorized. The vectorized data corresponding to the categorical features 706 and the numerical features 708 is provided to the system 102 or the neural network 106 for anomaly detection.

FIG. 7B illustrates a block diagram 700B of the neural network 106 for performing robust transformation 712 for discrete categorical input 710 comprising the categorical features 706 and the numerical features 708, according to some embodiments of the present disclosure.

However, the necessary possibilities of adversarial input that may be generated from the input 710 may be very large and may have semantic meaning making it difficult to handle the size and discrete nature of the input 710. Thus, to handle the size and discrete nature of the input 710 for adversarial training, the neural network 106 performs robust transformation 712 for each feature of the plurality of features present in the URL 704, to convert each word and/or numbers to a smaller dimensional feature vector in a continuous space to generate continuous embedding rather than adding randomness or noise to discrete values. Thus, these embedding vectors (i.e., feature vectors) are used in place of the original discrete features by the neural network 106 to work with, i.e., perform robust transformation.

In order to perform the robust transformation 712 for the discrete categorical input 710 (referred to as input 710, hereinafter), the neural network 106 is configured to use the embedding subnetwork 108 to generate the continuous embedding for the input 710. Further, a set of random noises of a predetermined magnitude, such as a set of noise tensors are injected into tensors of the continuous embeddings of the categorical features 706 and the numerical features 708 to produce a set of perturbed embeddings. Further, each of the set of perturbed embeddings is processed with the transformation subnetwork 110 to produce a set of transformations. Based on a combination of the set of transformations, the neural network 106 is configured to output the robust transformation 712 of the discrete input 710.

The robust transformation 712 performed by the neural network 106 is based on randomized smoothing where random perturbations are added to the input, i.e., the input 710 in embedded in the continuous space. Further, the robust transformation 712 is processed with the neural network 106 or the system 102 to produce a result of anomaly detection or adversarial attack detection.

### Overview of Exemplary Method

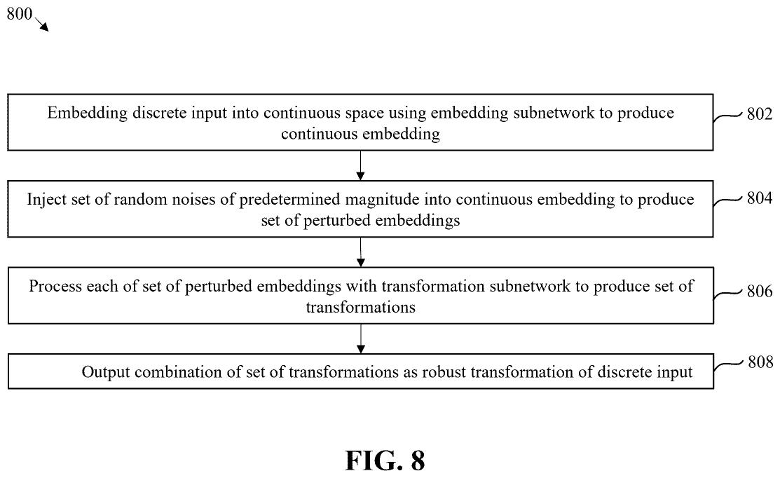

FIG. 8 illustrates a flowchart 800 of a computer-implemented AI method for generating transformation of the discrete input 104, in accordance with an example embodiment. FIG. 8 is explained in conjunction with FIG. 1, FIG. 2, FIG. 3, FIG. 4A, FIG. 4B, FIG. 4C, FIG. 5 and FIG. 6.

At 802, the discrete input 104 is embedded into a continuous space using the embedding subnetwork 108 to produce a continuous embedding 204. In an example, the system 102 is configured to utilize the embedding subnetwork 108 to embed the discrete input 104. In an example, the continuous embedding 204 of the discrete input 104 may include continuous embedding vectors 304. In an example, the continuous embedding 204 includes a tensor of floating-point values.

At 804, a set of random noises 206 of a predetermined magnitude is injected into the continuous embedding 204 to produce a set of perturbed embeddings 208. In an example, the set of random noises 206 may be a set of Gaussian noise tensors 308. For example, a Gaussian noise tensor from the set of Gaussian noise tensors 308 may be added to a corresponding tensor of floating-point values of the continuous embedding 204. In an example, the system 102 is configured to add the set of Gaussian noise tensors to the tensors of the continuous embedding 204 in parallel.

At 806, each of the set of perturbed embeddings 208 is processed with the transformation subnetwork 110 to produce a set of transformations 212. In an example, the system 102 is configured to utilize the transformation subnetwork 110, specifically, hidden layers of the transformation subnetwork 110, to transform the set of perturbed embeddings 208 to the set of transformations 212 based on a task for which the transformation subnetwork 110 is trained.

At 808, a combination of the set of transformations 212 is output as the robust transformation 112 of the discrete input 104. Further, the system 102 is configured to output the combination of the set of transformations 212 as an aggregation or, an average of the set of transformations 212. In another example, the system 102 is configured to output the combination of the set of transformations 212 as an average of probability vectors of the set of transformations 212, or a majority of heard decision of the probability vectors of the set of transformations 212. In this manner, a robust transformation is generated from the discrete input 104 which enables the neural network 106 to form defense against adversarial attacks.

### Exemplar Implementation

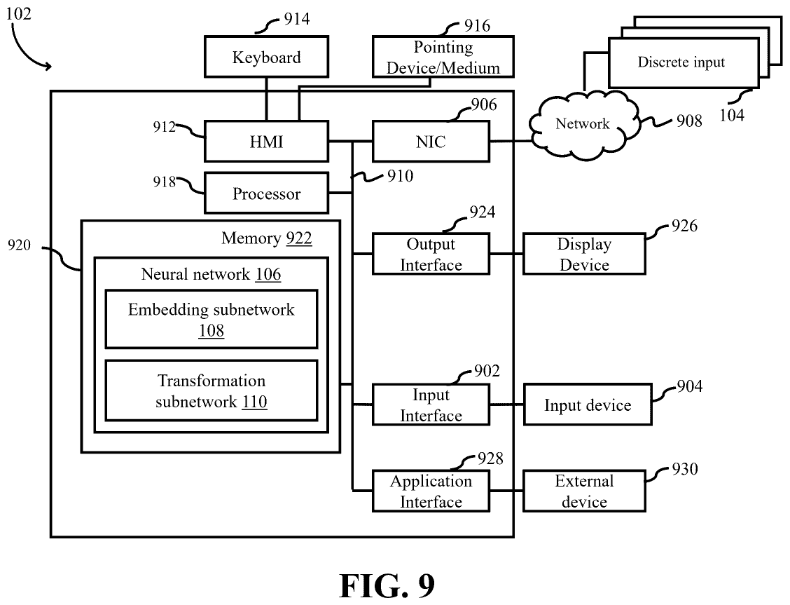

FIG. 9 illustrates a block diagram of a computer-based AI system 102 for generating transformation of the discrete input 104, in accordance with an example embodiment. The computer-based AI system 102 includes a number of interfaces connecting the system 102 with other systems and devices. The AI system 102 includes an input interface 902 configured to accept the discrete input 104 or the categorical input 302, where the discrete input 104 comprises discrete data such as internet proxy data, text data, video data, audio data, image data, or the likes.

In some embodiments, the AI system 102 includes a network interface controller (NIC) 906 configured to obtain the discrete input 104, via a network 908, which can be one or combination of wired and wireless network.

The network interface controller (NIC) 906 is adapted to connect the AI system 102 through a bus 910 to the network 908 connecting the AI system 102 with an input device 904. The input device 904 may correspond to a proxy log data recorder that records proxy log data to be provided to the AI system 102 to generate or perform robust transformations corresponding to proxy log data.

Additionally, or alternatively, the AI system 102 may include a human machine interface (HMI) 912. The human machine interface 912 within the AI system 102 connects the AI system 102 to a keyboard 914 and pointing device 916, where the pointing device 916 may include a mouse, trackball, touchpad, joystick, pointing stick, stylus, or touchscreen, among others.

The AI system 102 includes a processor 918 configured to execute stored instructions 920, as well as a memory 922 that stores instructions that are executable by the processor 918. The processor 918 can be a single core processor, a multi-core processor, a computing cluster, or any number of other configurations. The memory 922 can include random access memory (RAM), read only memory (ROM), flash memory, or any other suitable memory systems. The processor 918 may be connected through the bus 910 to one or more input and output devices.

The instructions 920 may implement a method for generating transformation of the discrete input 104, according to some embodiments. To that end, computer memory 922 stores the neural network 106 comprising the embedding subnetwork 108 and the transformation subnetwork 110.

The embedding subnetwork 108 may generate embedding of the discrete input 104 in the continuous space as the continuous embedding 204. The continuous embedding may transform the discrete input 104 into continuous representation while maintaining semantic relationship between values of the discrete input 104. Further, the set of random noises 206 are added to the continuous embedding 204 such that noise samples of predefined magnitude are added to each embedding in the continuous embedding 204 to generate the set of perturbed embeddings 208. Further, the transformation subnetwork 110 may transform the set of perturbed embeddings 208 to generate the set of transformations 212 associated with a task. The set of transformations 212 may be combined to generate an output. Such output corresponds to the robust transformation 112 of the discrete input 104.

In some embodiments, an output interface 924 may be configured to render the output, i.e., the combination of the set of transformations 212, on a display device 926. Examples of a display device 926 include a computer monitor, television, projector, or mobile device, among others. The computer-based AI system 102 can also be connected to an application interface 928 adapted to connect the computer-based AI system 102 to an external device 930 for performing various tasks.

### Embodiments

The description provides exemplary embodiments only, and is not intended to limit the scope, applicability, or configuration of the disclosure. Rather, the following description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the following description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like reference numbers and designations in the various drawings indicated like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine-readable medium. A processor(s) may perform the necessary tasks.

Further, embodiments of the present disclosure and the functional operations described in this specification can be implemented in digital electronic circuitry, in tangibly embodied computer software or firmware, in computer hardware, including the structures disclosed in this specification and their structural equivalents, or in combinations of one or more of them.

Further some embodiments of the present disclosure can be implemented as one or more computer programs, i.e., one or more modules of computer program instructions encoded on a tangible non transitory program carrier for execution by, or to control the operation of, data processing apparatus. Further still, program instructions can be encoded on an artificially generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code.

A computer program can be deployed to be executed on one computer or on multiple computers that are located at one site or distributed across multiple sites and interconnected by a communication network. Computers suitable for the execution of a computer program include, by way of example, can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data.

Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship with each other.

Although the present disclosure has been described with reference to certain preferred embodiments, it is to be understood that various other adaptations and modifications can be made within the spirit and scope of the present disclosure. Therefore, it is the aspect of the append claims to cover all such variations and modifications as come within the true spirit and scope of the present disclosure.

What is claimed is:

1. A computer-implemented artificial intelligence (AI) method for robust transformation of a discrete input with a neural network including an embedding subnetwork and a transformation subnetwork, comprising:
embedding the discrete input into a continuous space using the embedding subnetwork to produce a continuous embedding;
injecting a set of random noises of a predetermined magnitude into the continuous embedding to produce a set of perturbed embeddings;
processing each of the set of perturbed embeddings with the transformation subnetwork to produce a set of transformations; and
outputting a combination of the set of transformations as the robust transformation of the discrete input.

2. The AI method of claim 1, wherein the discrete input includes a tensor of one or more categorical values.

3. The AI method of claim 1, wherein the discrete input is internet proxy log data.

4. The AI method of claim 1, wherein the continuous embedding includes a tensor of floating-point values.

5. The AI method of claim 4, wherein the set of random noises includes a set of Gaussian noise tensors, wherein each of the Gaussian noise tensors has a shape of the tensor of floating-point values and includes independent Gaussian samples having a mean of zero and a standard deviation defined by the predetermined magnitude.

6. The AI method of claim 5, wherein each of the perturbed embeddings is formed by adding the tensor of floating-point values to one of the Gaussian noise tensors.

7. The AI method of claim 1, wherein the transformation subnetwork is a deep neural network trained for one or a combination of: automatic speech recognition, language modelling, and log data modelling.

8. The AI method of claim 1, wherein the combination of the set of transformations is an aggregation of the set of transformations.

9. The AI method of claim 1, wherein each of the set of transformations is a continuous tensor, such that the robust transformation is determined as an average of the set of transformations.

10. The AI method of claim 1, wherein each of the set of transformations is a tensor of one or more vectors of logits, the method further comprising:
converting each of the one or more vectors of logits into a probability vector via a softmax operation to produce a set of probability vectors;
averaging the set of probability vectors in a probability space to produce an average probability vector; and
determining the robust transformation of the discrete input using the average probability vector.

11. The AI method of claim 10, further comprising:
converting the average probability vector with log-likelihoods to produce the robust transformation of the discrete input.

12. The AI method of claim 1, wherein each of the set of transformations is a tensor of one or more vectors of logits, the method further comprising:
converting each of the one or more vectors of logits into a hard decision by selecting an index of a largest logit value to produce a set of hard decisions; and
aggregating the set of hard decisions to produce the robust transformation of the discrete input.

13. The AI method of claim 1, wherein the neural network is trained with training samples of the discrete input.

14. The AI method of claim 1, wherein the neural network is trained with training samples of the discrete input modified with noise in the continuous space.

15. The AI method of claim 14, wherein the training comprises:
embedding a training sample of the discrete input with the embedding subnetwork into the continuous space to produce a training embedding;
perturbing the training embedding multiple times with a random noise to produce a set of perturbed training embeddings;
processing each of the set of perturbed training embeddings with the transformation subnetwork to produce a set of training transformations;
combining the set of training transformations into a combined training output; and
updating parameters of the embedding subnetwork and the transformation subnetwork based on a loss function of the combined training output.

16. An artificial intelligence (AI) system for robust transformation of a discrete input with a neural network including an embedding subnetwork and a transformation subnetwork, comprising:
a memory that stores instructions;
a processor configured to execute the instructions to:
embed, using the embedding subnetwork, the discrete input into a continuous space to produce a continuous embedding;
inject a set of random noises of a predetermined magnitude into the continuous embedding to produce a set of perturbed embeddings;
process, using the transformation subnetwork, each of the set of perturbed embeddings to produce a set of transformations; and
output a combination of the set of transformations as the robust transformation of the discrete input.

17. The AI system of claim 16, wherein the neural network is trained with training samples of the discrete input modified with noise in the continuous space, and wherein to train the neural network the processor is configured to:
embed, using the embedding subnetwork, a training sample of the discrete input into the continuous space to produce a training embedding;
perturb the training embedding multiple times with a random noise to produce a set of perturbed training embeddings;
process, using the transformation subnetwork, each of the set of perturbed training embeddings to produce a set of training transformations;
combine the set of training transformations into a combined training output; and
update parameters of the embedding subnetwork and the transformation subnetwork based on a loss function of the combined training output.

18. The AI system of claim 16, wherein each of the set of transformations is a tensor of one or more vectors of logits, and wherein the processor is further configured to:
convert each of the one or more vectors of logits into a probability vector via a softmax operation to produce a set of probability vectors;
average the set of probability vectors in a probability space to produce an average probability vector; and
determine the robust transformation of the discrete input using the average probability vector.

19. The AI system of claim 16, wherein the processor is further configured to:
convert the average probability vector with log-likelihoods to produce the robust transformation of the discrete input.

20. A non-transitory computer readable storage medium embodied thereon a program executable by a processor for performing a method for robust transformation of a discrete input with a neural network including an embedding subnetwork and a transformation subnetwork, the method comprising:
embedding the discrete input into a continuous space using the embedding subnetwork to produce a continuous embedding;
injecting a set of random noises of a predetermined magnitude into the continuous embedding to produce a set of perturbed embeddings;
processing each of the set of perturbed embeddings with the transformation subnetwork to produce a set of transformations; and
outputting a combination of the set of transformations as the robust transformation of the discrete input.
